(19) United States
(12) Patent Application Publication
(10) Pub. No.: US 2002/0141307 A1
(43) Pub. Date: Oct. 3, 2002

(54) Information reproduction apparatus, signal processing apparatus, and information reproduction method

(75) Inventors: Hiroki Kuribayashi, Tsurugashima-shi (JP); Takuma Yanagisawa, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/097,325

(22) Filed: Mar. 15, 2002

(30) Foreign Application Priority Data
Mar. 30, 2001 (JP) P2001-98236

(51) Int. Cl. G11B 7/00

(52) U.S. Cl. 369/47.17; 369/53.33

(57) ABSTRACT

There are disclosed an information reproduction apparatus, signal processing apparatus, and information reproduction method which can remove a crosstalk to a wobble signal, particularly a crosstalk attributed to an RF signal. The information reproduction apparatus for reading information of an optical recording medium includes a detector for outputting a difference between individual output signals optically obtained by a pair of detectors for reading the information of a first track, a detector for reading RF information of a second track adjacent to the first track, a demodulator for demodulating a detection signal outputted from the detector, and a crosstalk canceller which uses the detection signal outputted from the detector to cancel the crosstalk arising from the RF information of the track included in the detection signal outputted from the detector.

### BACKGROUND OF THE INVENTION

1. Field of the Invention

The present invention relates to an information reproduction apparatus, signal processing apparatus, and information reproduction method in which information of an optical recording medium is reproduced, particularly to an information reproduction apparatus, signal to processing apparatus, and information reproduction method in which an optical recording medium having a short track interval can be handled.

2. Description of the Prior Art

At present, optical disks represented by CD and DVD have practically been used. In recent years, a CD-digital audio, (CD-DA) as a recording medium for exclusive use in reproduction, further a CD-Recordable (CD-R) in which digital data can be recorded only once, a CD-rewritable (CD-RW) in which the digital data can be rewritten a plurality of times, and the like have also practically been used.

During recording or reproducing with respect to an optical disk, the optical disk needs to be rotated at a predetermined speed. With the recording medium for exclusive use in reproduction, when the rotation speed is synchronized with a reproduction frequency of the digital data during the reproduction, a predetermined rotation speed can be obtained. On the other hand, in recordable recording media such as CD-R and CD-RW, the digital data is not recorded in a track in an initial state, and the rotation speed cannot be controlled using a similar method. Therefore, in the recordable recording media, the track (groove track) is wobbled in accordance with address information, the rotation speed is controlled based on a wobble signal read from the track, and a track address is recognized.

As a current practically used recording method of the address information by wobbling, a method of recording an FM modulated wobble signal in the track is known. Moreover, Japanese Patent Application Laid-Open No. 69646/1998 discloses a method of modulating a phase of the wobble signal to record the address information in the track.

However, there has been a demand for further enhancement of a recording density with respect to the optical disk. Moreover, in order to enhance the recording density of the optical disk, an interval of the track formed in a spiral form (interval of a radial direction of the optical disk) is necessarily reduced. Therefore, it is difficult to completely restrict a spot diameter of a laser beam to a region formed in a predetermined track, and there is a problem that a crosstalk from the adjacent track is generated.

Moreover, it has been found by an experiment by the present inventor et al. that a phenomenon of mixture of a high frequency signal (RF signal) recorded in the track during reproduction into the wobble signal occurs.

### SUMMARY OF THE INVENTION

An object of the present invention is to provide an information reproduction apparatus in which a crosstalk into a wobble signal, particularly a crosstalk attributed to an RF signal after data recording can be eliminated.

According to the present invention, there is provided an information reproduction apparatus for reading wobble information and RF information from an optical recording medium. The apparatus includes wobble detection device (152) for detecting a wobble signal from the wobble information, RF detection device (151, 152, etc.) for detecting an RF signal from the RF information, and crosstalk cancel device (3k, etc.) which uses the RF signal to cancel a crosstalk arising from the RF information included in the wobble signal.

Since the crosstalk cancel device for canceling the crosstalk arising from the RF information included in the wobble signal is disposed, the crosstalk arising from the RF information into the wobble signal can effectively be removed.

The wobble detection device (152) may detect the wobble signal from a first track (MT), and the RF detection device (151) may detect the RF signal from a second track (ST1) disposed adjacent to the first track (MT).

In this case, the crosstalk arising from the RF information of the second track can effectively be removed.

There is provided position deviation compensation device (11 to 14) for compensating a timing corresponding to a position deviation with respect to an information reading direction of the wobble detection device (152) and RF detection device (151, 152). The wobble signal and RF signal whose timings are adjusted by the position deviation compensation device (11 to 14) may be used to execute a control in the crosstalk cancel device (3k, etc.).

In this case, while the timing of the signal extracted via the wobble detection device is adjusted to the timing of the signal extracted via the RF detection signal, the crosstalk is canceled. Therefore, the crosstalk can effectively be removed.

The wobble detection device (152) may detect the wobble signal from the first track (MT), and the RF detection device (152) may detect the RF signal from the first track (MT).

In this case, the crosstalk arising from the RF information of the first track can effectively be removed.

There are provided crosstalk extraction device (1C, etc.) for extracting the crosstalk included in the wobble signal, and coefficient control device (3k, etc.) for controlling a coefficient based on the crosstalk extracted by the crosstalk extraction device (1C, etc.). The crosstalk cancel device (3e, etc.) may cancel the crosstalk by the coefficient calculated by the coefficient control device (3k, etc.).

In this case, the crosstalk arising from the RF information included in the wobble signal detected by the wobble detection device is extracted, the coefficient is controlled based on the extracted crosstalk, and the crosstalk is canceled by the coefficient, so that the crosstalk of the RF signal with respect to the wobble signal can efficiently be removed.

The coefficient control device (3k, etc.) may calculate a correlation between the crosstalk extracted by the crosstalk extraction device (1C, etc.) and the RF signal, and control the coefficient for use in the crosstalk cancel device (3e) so that the correlation is reduced.

In this case, the coefficient is controlled so that the correlation between the crosstalk extracted by the crosstalk extraction device and the RF signal is reduced. Therefore, the crosstalk can effectively be canceled, and the crosstalk of the RF signal to the wobble signal can efficiently be removed.

There are provided wobble demodulation device (2C, etc.) for demodulating the wobble signal, and RF demodulation device (3i, etc.) for demodulating the RF signal. The crosstalk extraction device (1C, etc.) may extract the crosstalk from the signal demodulated by the wobble demodulation device (3i, etc.), and the coefficient control device (3j, etc.) may control the coefficient based on the correlation between the crosstalk extracted by the crosstalk extraction device (1c, etc.) and the signal demodulated by the RF demodulation device (3i, etc.).

In this case, since the crosstalk is extracted from the demodulated signal, the crosstalk can efficiently be extracted.

The crosstalk extraction device includes data pattern determination device for determining a data pattern based on a value of an output signal of the wobble demodulation device after the crosstalk is canceled, and reference level generation device for generating a reference level corresponding to a determined result of the data pattern determination device. The reference level may be compared with the value of the output signal of the wobble demodulation device after the crosstalk is canceled, and the crosstalk may be extracted.

In this case, the reference level is compared with the value of the output signal of the wobble demodulation device after the crosstalk is canceled, and the crosstalk is extracted, so that a crosstalk component can efficiently be detected.

There is provided error rate detection device for detecting an error rate of the wobble signal, and the crosstalk cancel device may cancel the crosstalk so that the error rate detected by the error rate detection device is reduced.

In this case, since the error rate is controlled to be reduced, the crosstalk can efficiently be removed.

There is provided jitter detection device for detecting a jitter of the wobble signal, and the crosstalk cancel device may cancel the crosstalk so that the jitter detected by the jitter detection device is reduced.

In this case, since the jitter is controlled to be reduced, the crosstalk can efficiently be removed.

The wobble detection device (152) detects the wobble signal from the first track (MT). The RF detection device (151, 152) may include: first RF detection device (152) for detecting the RF signal from the first track (MT); second RF detection device (151) for detecting the RF signal from the second track (ST1) disposed adjacent to the first track (MT); and third RF detection device (153) for detecting the RF signal from a third track (ST2) which is adjacent to the first track (MT) and different from the second track (ST1).

In this case, the crosstalk arising from the RF information of the first, second, and third tracks detected by the first, second, and third RF detection device can be canceled.

According to the present invention, there is provided a signal processing apparatus applied to an information reproduction apparatus which reads wobble information and RF information of an optical recording medium. The signal processing apparatus includes: wobble detection device (152) for detecting a wobble signal from the wobble information; RF detection device (152, 151, etc.) for detecting an RF signal from the RF information; and crosstalk cancel device (3k, etc.) for using the RF signal to cancel a crosstalk arising from the RF information included in the wobble signal.

Since the signal processing apparatus includes the crosstalk cancel device for canceling the crosstalk arising from the RF information included in the wobble signal, the crosstalk arising from the RF information with respect to the wobble signal can effectively be removed.

According to the present invention, there is provided an information reproduction method in which wobble information and RF information of an optical recording medium are read. The method includes: a wobble detecting step of detecting a wobble signal from the wobble information; an RF detecting step of detecting an RF signal from the RF information; and a crosstalk cancel step of using the RF signal to cancel a crosstalk arising from the RF information included in the wobble signal.

Since the information reproduction method includes the crosstalk cancel step of canceling the crosstalk arising from the RF information included in the wobble signal, the crosstalk arising from the RF information with respect to the wobble signal can effectively be removed.

Additionally, for ease of understanding the present invention, reference numerals in the accompanying drawings are added within parentheses, but this does not limit the present invention to shown embodiments.

### BRIEF DESCRIPTION OF THE DRAWINGS

FIG. 1 is a diagram showing a model of a simulation using a straight groove;

FIG. 2A shows diagrams of simulation results of strength distributions of a detection surface which catches a reflected light from a spot SP, and is a two-dimensional diagram of the strength distribution in a case in which the spot SP is in a point A of FIG. 1;

FIG. 2B shows diagrams of simulation results of strength distributions of a detection surface which catches a reflected light from a spot SP, and is a three-dimensional diagram of the strength distribution in a case in which the spot SP is in a point A of FIG. 1;

FIG. 2C shows diagrams of simulation results of strength distributions of a detection surface which catches a reflected light from a spot SP, and is a two-dimensional diagram of the strength distribution in a case in which the spot SP is in a point B of FIG. 1;

FIG. 2D shows diagrams of simulation results of strength distributions of a detection surface which catches a reflected light from a spot SP, and is a three-dimensional diagram of the strength distribution in a case in which the spot SP is in a point B of FIG. 1;

FIG. 3A is a diagram showing the simulation result of a push-pull signal waveform of a main track MT;

FIG. 3B is a diagram showing the simulation result of an RF signal waveform in a case in which a track ST1 disposed adjacent to a main track MT is reproduced;

FIG. 4 is a diagram showing a calculation model of the simulation;

FIGS. 5A and 5B are diagrams showing the simulation result of an eye pattern of an address signal obtained by demodulating the wobble signal of the main track MT;

FIG. 6 is a diagram showing the model for simulation of leaking of an RF signal of the main track with respect to the wobble signal of the main track;

FIG. 7 is a diagram showing the simulation result of the push-pull signal waveform of the main track MT;

FIG. 8 is a diagram showing the calculation model of the simulation;

FIGS. 9A and 9B are diagrams showing the simulation result of the eye pattern of the address signal obtained by demodulating the wobble signal of the main track MT;

FIG. 10 is a diagram showing one example of a basic constitution of an information reproduction apparatus according to the present invention;

FIG. 11 is a diagram showing another example of the basic constitution of the information reproduction apparatus according to the present invention;

FIG. 12 is a diagram showing further example of the basic constitution of the information reproduction apparatus according to the present invention;

FIG. 13 is a diagram showing further example of the basic constitution of the information reproduction apparatus according to the present invention;

FIG. 14 is a diagram showing the apparatus of FIG. 13 to which a delay unit is added;

FIG. 15 is a diagram showing a recording system of address information in an optical disk;

FIGS. 16A and 16B are diagrams showing a demodulation method of the address information in the optical disk;

FIG. 17A shows diagrams of one example of an optical system, and is a diagram showing the constitution of the optical system;

FIG. 17B shows diagrams of one example of an optical system, and is a diagram showing the constitution of a detector.

FIG. 18A is a diagram showing the wobble signal waveform which does not include a crosstalk or a noise;

FIG. 18B is a diagram showing the wobble signal waveform which includes the crosstalk and noise;

FIG. 18C is a diagram showing the signal waveform obtained by demodulating the waveform of FIG. 18B;

FIG. 19 is a schematic diagram showing one example of an applied coefficient control method;

FIG. 20 is a diagram showing the waveform after the demodulation of the main track and an ideal waveform which does not include the crosstalk;

FIG. 21 is a schematic diagram showing a constitution for detecting an error.

FIG. 22 is a diagram showing the waveform after the demodulation of the main track and the ideal waveform including no crosstalk in a case in which a level in a 0 cross point is used in a method for detecting the error;

FIG. 23 is a schematic diagram showing a constitution for detecting the error;

FIG. 24 is a diagram showing the waveform after the demodulation of the main track and the ideal waveform including no crosstalk in a method for comparing a value of the demodulated signal of the main track after canceling the crosstalk, and a value of the 0 cross point with a reference level;

FIG. 25 is a schematic diagram showing a constitution for detecting the error;

FIG. 26 is a flowchart showing a processing for controlling the coefficient based on an error rate;

FIG. 27 is a diagram showing a relation between the error rate and a crosstalk amount, and a relation between the error rate and a coefficient k; and

FIG. 28 is a diagram showing the constitution of the information reproduction apparatus according to an embodiment.

### DESCRIPTION OF THE PREFERRED EMBODIMENT

Information Reproduction Apparatus

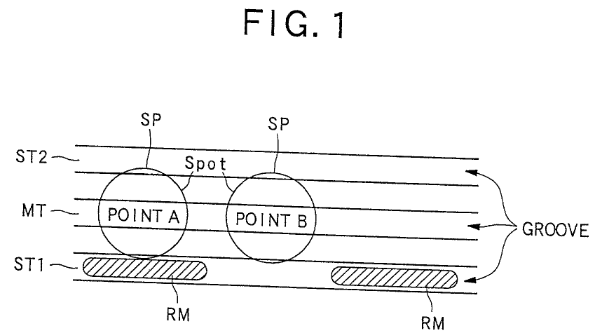

An information reproduction apparatus according to the present invention will be described hereinafter with reference to FIGS. 1 to 28.

First, an RF signal of an adjacent track, which leaks into a reproduction signal of wobble, and an effect obtained by canceling the RF signal will be described. Additionally, the wobble is formed to record address information, and the like. A recording system of the address information will concretely be described later.

FIG. 1 shows a model of a simulation using a straight groove. In the model shown in FIG. 1, a recording mark RM is formed only in an adjacent track ST1 on a right side with respect to an advancing direction of a spot SP of a laser beam. That is, RF data is recorded only in the adjacent track ST1 on the right side with respect to the advancing direction of the spot SP. The RF data is not recorded in a main track MT being reproduced, and an adjacent track ST2 on a left side with respect to the advancing direction of the spot SP.

As parameters of the simulation, a numerical aperture (NA)=0.6, wavelength of the laser beam λ=650 nm, and track pitch of 0.683 μm are selected.

In FIG. 1, the main track MT is straight. Therefore, if there is completely no crosstalk of the RF signal to a push-pull signal of the main track MT, the push-pull signal of the main track is constantly 0. That is, a signal appearing when the push-pull signal of the main track MT is calculated with the model shown in FIG. 1 is a crosstalk from the adjacent track.

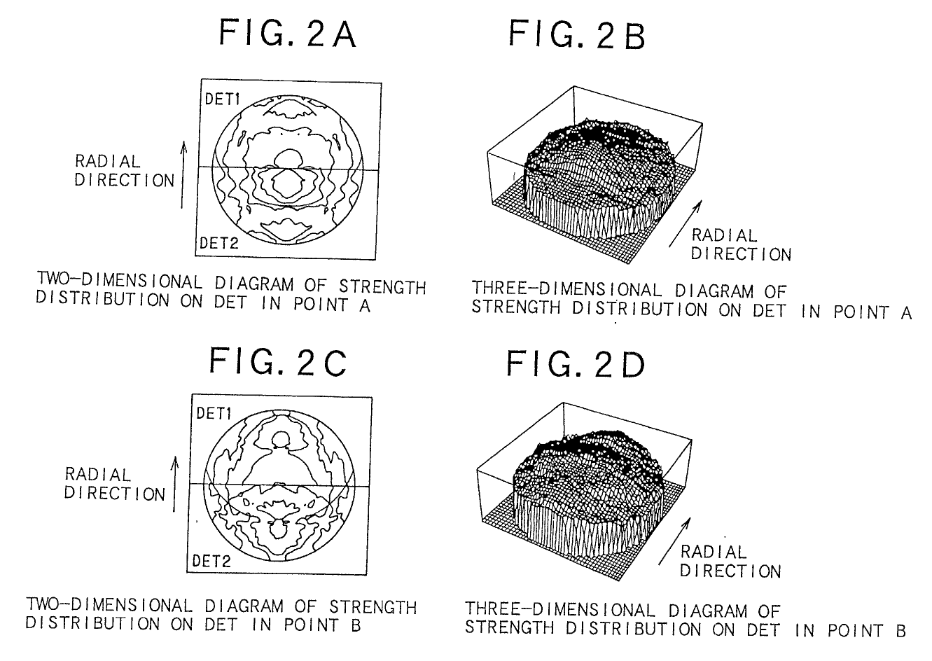

FIGS. 2A to 2D show simulation results of strength distributions of a detection surface which catches a reflected light from each spot SP. FIG. 2A is a two-dimensional diagram of the strength distribution in a case in which the spot SP is in a point A of FIG. 1, and FIG. 2B is a three-dimensional diagram of the strength distribution in this case. FIG. 2C is a two-dimensional diagram of the strength distribution in a case in which the spot SP is in a point B of FIG. 1, and FIG. 2D is a three-dimensional diagram of the strength distribution in this case. A “radial direction” shown in the drawings indicates the radial direction of an optical disk. This direction corresponds to a vertical direction in FIG. 1.

In FIGS. 2A and 2C, an upper half of each circle shows a detection surface of one detector DET1, and a lower half of the circle shows the other detector DET2. The push-pull signal is a difference signal between detection signals of the detectors DET1 and DET2. Additionally, the RF signal is a sum signal of the detection signals of the detectors DET1 and DET2.

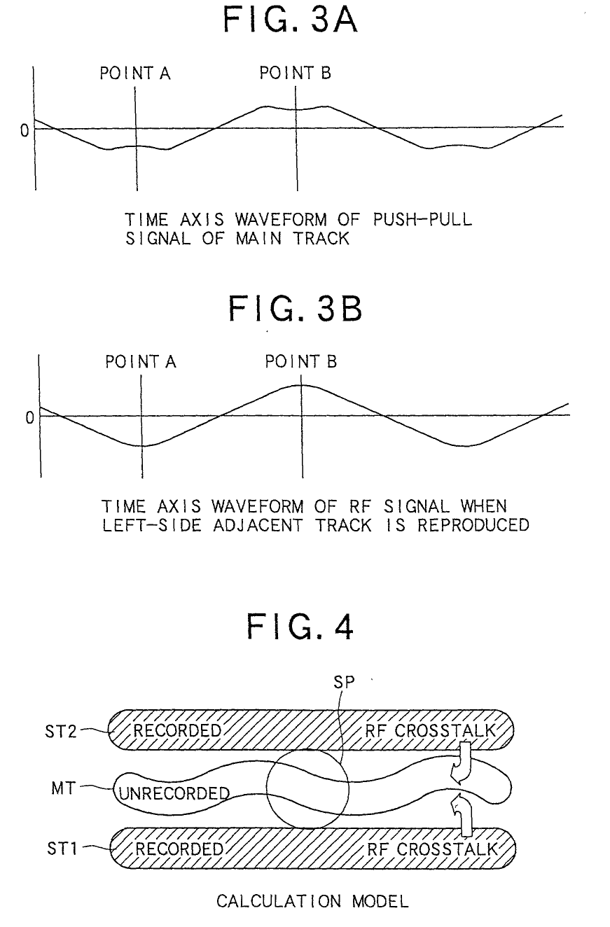

FIG. 3A shows the simulation result of a push-pull signal waveform of the main track MT. As described above, the push-pull signal corresponds to the crosstalk. FIG. 3B shows the simulation result of an RF signal waveform in a case in which the track ST1 disposed adjacent to the main track MT is reproduced. The abscissa in FIGS. 3A and 3B indicates time. Points A and B in FIGS. 3A and 3B indicate points of time at which the spot SP passes the points A and B in FIG. 1

As seen from comparison of FIG. 3A with FIG. 3B, the signal waveform of the push-pull signal of the main track MT is approximate to the signal waveform of the RF signal of the track ST1. Therefore, it is seen that the RF signal of the track ST1 leaks as the crosstalk into the push-pull signal of the main track MT.

The result of the simulation of an effect obtained by canceling the RF signal from the adjacent track will next be described in the optical disk in which address data is actually recorded by phase shift keying (PSK) modulation of the wobble.

FIG. 4 shows a calculation model of the simulation. As shown in FIG. 4, the RF data is not recorded in the wobbled main track MT, and the RF data is recorded in the tracks ST1 and ST2 formed as straight grooves on opposite sides of the main track MT The tracks ST1 and ST2 are formed as the straight grooves in this manner, in order that the crosstalk of the wobble signal from the adjacent track is prevented from occurring, and an influence of the crosstalk of the RF signal is purely verified. Moreover, it is assumed that there is no disk noise, in order to evaluate only the crosstalk of the RF signal.

As the parameters of the simulation, the numerical aperture (NA)=0.6, wavelength of the laser beam λ=650 nm, track pitch of 0.683 μm, and radial tilt=1.0 degree are selected.

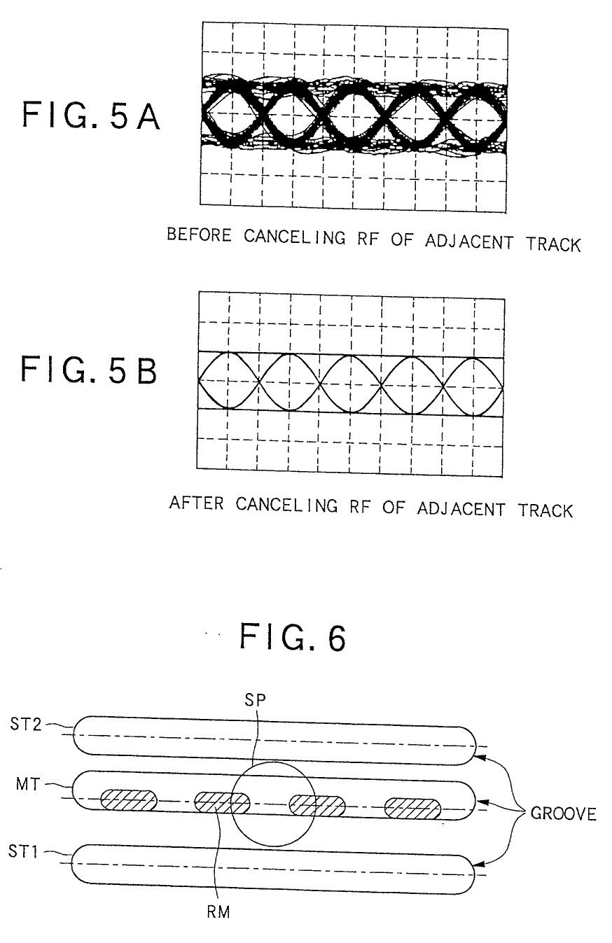

FIGS. 5A and 5B show the simulation results of an eye pattern of an address signal obtained by demodulating the wobble signal of the main track MT in the calculation model of FIG. 4. FIG. 5A shows the eye pattern before the RF signals leaking into the address signal from the adjacent tracks ST1 and ST2 are canceled. FIG. 5B shows the eye pattern after the RF signals leaking into the address signal from the adjacent tracks ST1 and ST2 are canceled.

As shown in FIG. 5A, for the eye pattern before the RF signals of the adjacent tracks ST1 and ST2 are canceled, the noise arising from the crosstalk is superimposed upon the wobble signal of the main track MT. On the other hand, as shown in FIG. 5B, the noise arising from the crosstalk is removed from the eye pattern after the RF signals of the adjacent tracks ST1, ST2 are canceled. The effect obtained by canceling the RF signal which leaks into the wobble signal of the main track MT from the adjacent track can be confirmed.

The RF signal of the main track, leaking into a reproduction signal of the wobble, and an effect obtained by canceling the RF signal will next be described.

FIG. 6 shows the model for simulation of leaking of the RF signal of the main track with respect to the wobble signal of the main track.

When a reproduced beam spot is overlapped with a center of the groove of the main track, and if there is no crosstalk from the adjacent track, a level of the push-pull signal (wobble signal) must be zero. In this case, even when the RF data is recorded in the main track, but when the recording mark RM is recorded without deviating from the center of the track, the RF data does not influence the push-pull signal. In other words, the RF signal of the main track MT does not leak into the wobble signal of the main track MT. However, in actual, because of eccentricity of the disk, and the like, the recording mark RM is recorded with not a little deviation to the left and right sides. As a result, the push-pull signal does not strictly turn to zero. Moreover, even if the recording mark RM is not displaced, the push-pull signal does not turn to zero because of the crosstalk from the adjacent track or the displacement (wobble) of the groove of the main track MT. In this case, the RF signal of the main track MT appears on the push-pull signal.

In the model shown in FIG. 6, the main track MT and the adjacent tracks ST1, ST2 on opposite sides of the main track MT are all formed in the straight grooves. Moreover, the main track MT is displaced (wobbled) from a track center line. The recording mark RM is on the track center line of the main track MT. Furthermore, the RF data is not recorded in the tracks ST1, ST2 on opposite sides of the main track MT.

As the parameters of the simulation in the model shown in FIG. 6, the numerical aperture (NA)=0.6, wavelength of the laser beam λ=650 nm, and track pitch of 0.683 μm are selected.

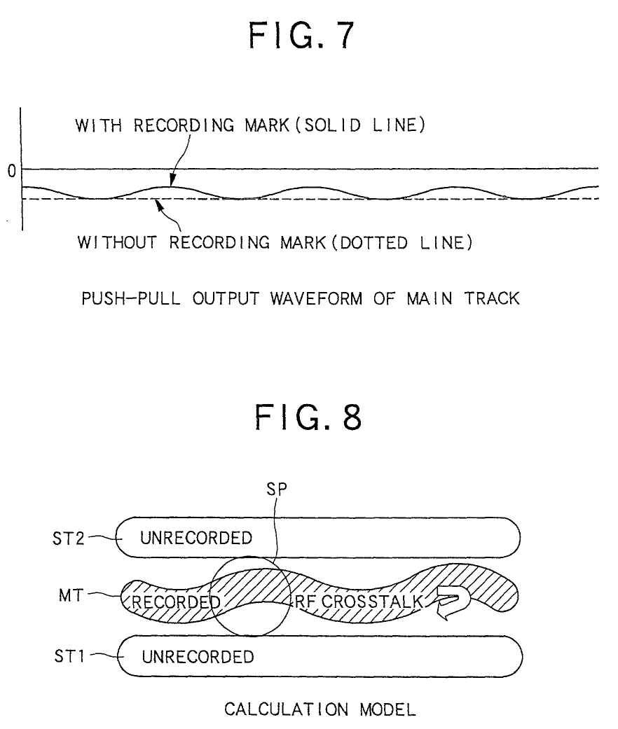

FIG. 7 shows the simulation result of the push-pull signal waveform of the main track MT in the model shown in FIG. 6, a solid line shows that there is the recording mark RM, and a dotted line shows that there is no recording mark. As shown in FIG. 7, with the presence of the recording mark RM, the RF signal of the main track MT leaks into the push-pull signal.

Therefore, in order to completely remove the influence of the RF signal on the wobble signal of the main track MT, not only the RF signal of the adjacent track but also the RF signal of the main track MT need to be canceled.

A result of the simulation of an effect obtained by canceling the RF signal of the main track MT will next be described in the optical disk in which the address data is actually recorded by the phase shift keying (PSK) modulation of the wobble.

FIG. 8 shows the calculation model of the simulation. As shown in FIG. 8, the RF data is recorded in the wobbled main track MT, and the RF data is not recorded in the tracks ST1 and ST2 formed as the straight grooves on opposite sides of the main track MT. The tracks ST1 and ST2 are formed as the straight grooves in this manner, in order that the crosstalk of the wobble signal from the adjacent track is prevented from occurring, and the influence of the crosstalk of the RF signal of the main track MT is purely verified. Moreover, it is assumed that there is no disk noise, in order to evaluate only the crosstalk of the RF signal.

The parameters of the simulation are the numerical aperture (NA)=0.6, wavelength of the laser beam λ=650 nm, track pitch of 0.683 μm, and radial tilt=1.0 degree.

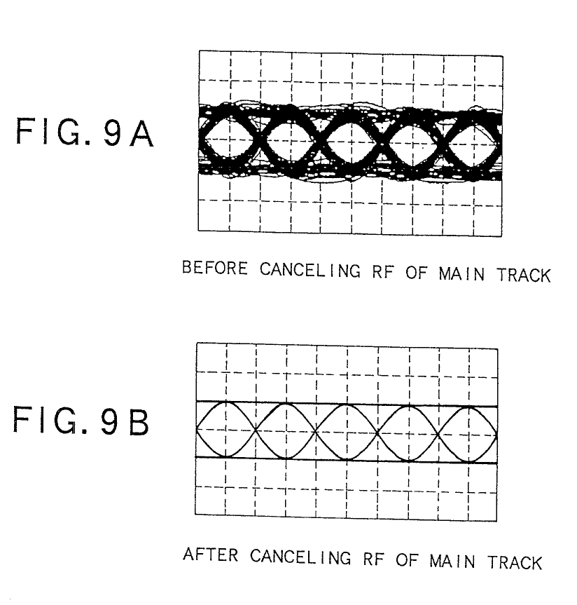

FIGS. 9A and 9B shows the simulation result of the eye pattern of the address signal obtained by demodulating the wobble signal of the main track MT in the calculation model of FIG. 8. FIG. 9A shows the eye pattern before the RF signal leaking into the address signal from the main track MT is canceled. FIG. 9B shows the eye pattern after the RF signal leaking into the address signal from the main track MT is canceled.

As shown in FIG. 9A, for the eye pattern before the RF signal of the main track MT is canceled, the noise arising from the crosstalk is superimposed upon the wobble signal of the main track MT. On the other hand, as shown in FIG. 9B, the noise arising from the crosstalk is removed from the eye pattern after the RF signal of the main track MT is canceled. The effect obtained by canceling the RF signal of the main track MT which leaks into the wobble signal of the main track MT can be confirmed.

(Basic Constitution of Information Reproduction Apparatus of the Present Invention)

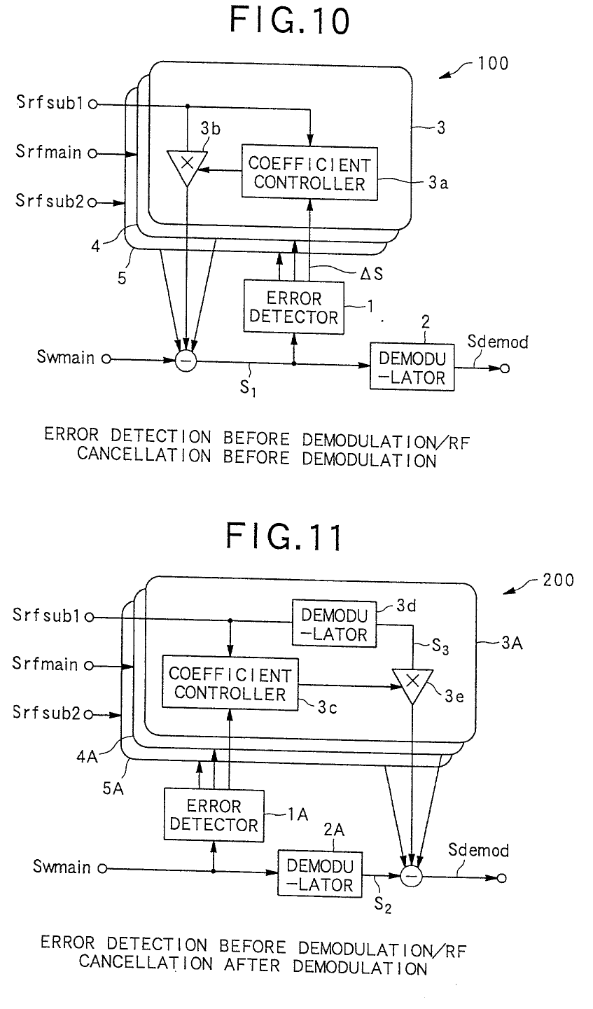

A basic constitution of the information reproduction apparatus of the present invention will be described hereinafter with reference to FIGS. 10 to 14.

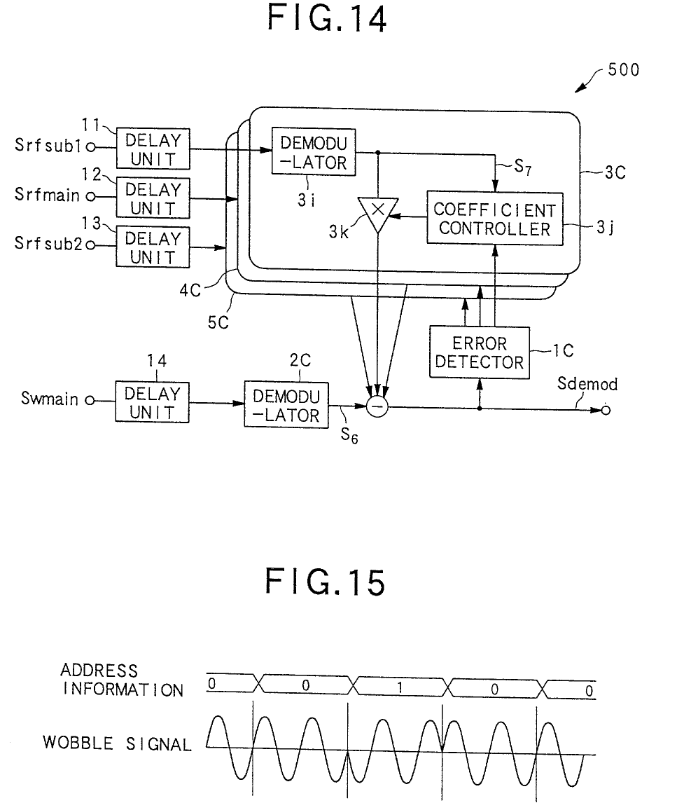

First, a recording system and demodulation method of the address information in an optical disk DK will be described with reference to FIGS. 15 16A and 16B.

As shown in FIG. 15, binary data of 0 and 1 are used to record the address information of the optical disk DK in the grooves. The groove is wobbled in a shape of a sine wave formed of a constant period, and the data 0 and 1 constituting the address information are recorded as the wobbles each of one period having phases of 0 and 180 degrees. The frequency of the wobble is positioned between a tracking servo frequency band and an RF signal frequency band.

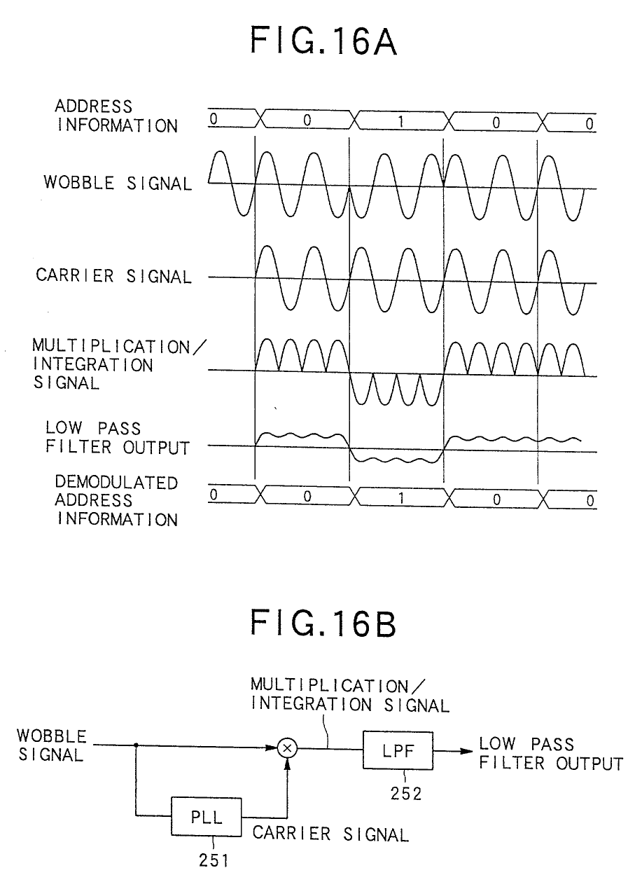

An operation of a phase shift keying (PSK) demodulator 2, and the like described later will next be described. FIG. 16A is a diagram showing a relation of the wobble signal, carrier signal, and multiplication/integration signal, and FIG. 16B is a diagram showing a circuit example for use in demodulation.

As shown in FIGS. 15 and 16A, the binary address information is modulated into two types of phases of 0 degree and 180 degrees of the wobble signal (sine wave) and recorded in the optical disk DK. A carrier signal shown in FIG. 16B (sine wave with a phase of 0 degree in FIG. 16A) is multiplied by the wobble signal, the multiplication signal obtained by the multiplication is passed through a low pass filter 252, and a demodulation signal indicating an output value (binary) corresponding to the phase of the wobble signal is obtained.

As shown in FIG. 16B, the carrier signal is generated by inputting the wobble signal into a PLL circuit 251. The carrier and wobble signals are subjected to multiplication/integration, the multiplication/integration signal is generated and further inputted into the low pass filter 252, and a low pass filter output is obtained.

The basic constitution of the information reproduction apparatus of the present invention will be described hereinafter.

FIG. 10 is a diagram showing one example of the basic constitution of the information reproduction apparatus according to the present invention. An information reproduction apparatus 100 detects an error (crosstalk) of the wobble signal before the demodulation, and cancels the crosstalk with respect to the wobble signal before the demodulation.

The apparatus 100 includes a detector (not shown) for detecting the information of the main track MT, a detector (not shown) for detecting the information of the track ST1 adjacent to the main track MT, and a detector (not shown) for detecting the information of the track ST2 adjacent to the main track MT. The detector for detecting the information of the main track MT outputs a wobble signal Swmain of the main track MT, the detector for detecting the information of the track ST1 outputs an RF signal Srfsub1 of the track ST1, and the detector for detecting the information of the track ST2 outputs an RF signal Srfsub2 of the track ST2.

Moreover, the apparatus 100 includes an error detector 1 for detecting the error (crosstalk) of the wobble signal before the demodulation of the main track, a phase shift keying (PSK) demodulator 2, a canceller 3 for canceling the RF signal of the track ST1, a canceller 4 for canceling the RF signal of the main track MT, and a canceller 5 for canceling the RF signal of the track ST2.

The canceller 3 includes a coefficient controller 3a, and a multiplier 3b to which a coefficient outputted from the coefficient controller 3a is given.

The error detector 1 detects and outputs an error ΔS included in a wobble signal S₁ after the cancellation. The coefficient controller 3a detects a correlation between the error ΔS and the RF signal Srfsub1, and outputs a coefficient k corresponding to the correlation. The coefficient k is supplied to the multiplier 3b, and multiplied by the RF signal Srfsub1.

As shown in FIG. 10, the output signal of the multiplier 3b is subtracted from the wobble signal Swmain of the main track MT detected by the detector, and the signal S₁ is obtained. Furthermore, the signal S₁ is demodulated in the demodulator 2, and an address demodulation signal Sdemod is outputted.

By the aforementioned feedback control, the coefficient of the multiplier 3b is controlled so that ΔS is minimized, that is, the crosstalk of the RF signal from the track ST1 to the address demodulation signal Sdemod is minimized. Thereby, the crosstalk of the RF signal of the track ST1 to the address demodulation signal Sdemod is canceled.

The cancellers 4 and 5 are constituted similarly as the canceller 3, and the RF signal of the main track MT and the RF signal of the track ST2 are canceled similarly as the RF signal of the track ST1 by the aforementioned operation.

As described above, the apparatus 100 of FIG. 10 detects the crosstalk of the RF signal before the demodulation, and cancels the crosstalk before the demodulation. Moreover, when a detection signal after the cancellation of the crosstalk is demodulated, the address demodulation signal is obtained. In this case, it is advantageously unnecessary to demodulate the RF signal having the crosstalk. On the other hand, since a complicated noise is mixed in an analog signal before the demodulation, it is disadvantageously difficult to detect the error (crosstalk).

FIG. 11 is a diagram showing another example of the basic constitution of the information reproduction apparatus according to the present invention. An apparatus 200 detects the error (crosstalk) of the wobble signal before the demodulation, and cancels the crosstalk from the demodulated wobble signal.

The apparatus 200 includes an error detector 1A for detecting the error (crosstalk) of the wobble signal before the demodulation of the main track, a phase shift keying (PSK) demodulator 2A for demodulating the wobble signal of the main track, a canceller 3A for canceling the RF signal of the track ST1, a canceller 4A for canceling the RF signal of the main track MT, and a canceller 5A for canceling the RF signal of the track ST2.

The canceller 3A includes a coefficient controller 3c, a demodulator 3d for demodulating the RF signal Srfsub1, and a multiplier 3e to which the coefficient outputted from the coefficient controller 3c is given.

The error detector 1A detects and outputs the error ΔS included in the wobble signal Swmain of the main track MT outputted from the detector. The coefficient controller 3c detects the correlation between the error ΔS and the RF signal Srfsub1, and outputs the coefficient k corresponding to the correlation. The coefficient k is supplied to the multiplier 3e, and multiplied by an output signal S₃ of the demodulator 3d.

As shown in FIG. 11, the wobble signal Swmain of the main track MT is demodulated by the demodulator 2A. Furthermore, an output signal of the multiplier 3e is subtracted from an output signal S₂ of the demodulator 2A, and the address demodulation signal Sdemod is outputted.

As described above, the crosstalk of the RF signals of the track ST1, main track MT, and track ST2 to the address demodulation signal Sdemod can be canceled.

The cancellers 4A and 5A are constituted similarly as the canceller 3A, and the RF signals of the main track MT and track ST2 are canceled similarly as the RF signal of the track ST1 by the aforementioned operation.

As described above, the apparatus 200 of FIG. 11 detects the crosstalk of the RF signal before the demodulation, and cancels the crosstalk after the demodulation, and the address demodulation signal is obtained.

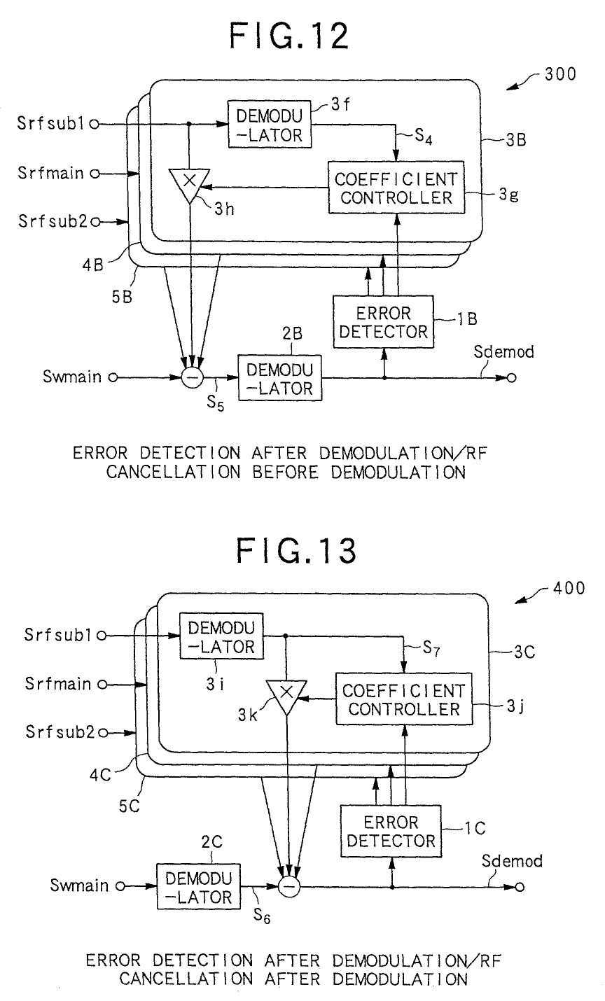

FIG. 12 is a diagram showing another example of the basic constitution of the information reproduction apparatus according to the present invention. An apparatus 300 detects the error (crosstalk) of the wobble signal after the demodulation, and cancels the crosstalk from the wobble signal before the demodulation.

The apparatus 300 includes an error detector 1B for detecting the error (crosstalk) of the wobble signal after the demodulation of the main track, a phase shift keying (PSK) demodulator 2B for demodulating the wobble signal of the main track MT, a canceller 3B for canceling the RF signal of the track ST1, a canceller 4B for canceling the RF signal of the main track MT, and a canceller 5B for canceling the RF signal of the track ST2.

The canceller 3B includes a demodulator 3f for demodulating the RF signal Srfsub1 of the track ST1 outputted from the detector, a coefficient controller 3g, and a multiplier 3h to which the coefficient outputted from the coefficient controller 3g is given.

The error detector 1B detects and outputs the error ΔS included in the wobble signal Sdemod obtained by further demodulating the signal after the cancellation of the crosstalk. The coefficient controller 3g detects the correlation between the error ΔS and a signal S₄ obtained by demodulating the RF signal Srfsub1, and outputs the coefficient k corresponding to the correlation. The coefficient k is supplied to the multiplier 3h, and multiplied by the RF signal Srfsub1.

As shown in FIG. 12, the output signal of the multiplier 3h is subtracted from the wobble signal Swmain of the main track MT detected by the detector, and a signal S₅ is obtained. Furthermore, the demodulator 2B demodulates the signal S₅, and outputs the address demodulation signal Sdemod.

By the aforementioned feedback control, the coefficient of the multiplier 3h is controlled so that ΔS is minimized, that is, the crosstalk of the RF signal from the track ST1 to the address demodulation signal Sdemod is minimized. Thereby, the crosstalk of the RF signal of the track ST1 to the address demodulation signal Sdemod is canceled.

The cancellers 4B and 5B are constituted similarly as the canceller 3B, and the RF signals of the main track MT and track ST2 are canceled similarly as the RF signal of the track ST1 by the aforementioned operation.

As described above, the apparatus 300 of FIG. 12 detects the crosstalk of the RF signal after the demodulation, and cancels the crosstalk before the demodulation. Moreover, the detection signal after the cancellation of the crosstalk is demodulated, and the address demodulation signal is obtained. In the apparatus 300, since the error (crosstalk) is detected from the demodulated wobble signal, the error can advantageously be detected with a high precision.

FIG. 13 is a diagram showing another example of the basic constitution of the information reproduction apparatus according to the present invention. An apparatus 400 detects the error (crosstalk) of the demodulated wobble signal, and cancels the crosstalk from the demodulated wobble signal.

The apparatus 400 includes an error detector 1C for detecting the error (crosstalk) of the wobble signal after the demodulation of the main track, a phase shift keying (PSK) demodulator 2C for demodulating the wobble signal of the main track MT, a canceller 3C for canceling the RF signal of the track ST1, a canceller 4C for canceling the RF signal of the main track MT, and a canceller 5C for canceling the RF signal of the track ST2.

The canceller 3C includes a demodulator 3i for demodulating the RF signal Srfsub1 of the track ST1 outputted from the detector, a coefficient controller 3j, and a multiplier 3k to which the coefficient outputted from the coefficient controller 3j is given.

The error detector 1C detects and outputs the error ΔS included in the wobble signal Sdemod obtained by canceling the crosstalk from an output signal S₆ of the demodulator 2C. The coefficient controller 3j detects the correlation between the error ΔS and a signal S₇ obtained by demodulating the RF signal Srfsub1, and outputs the coefficient k corresponding to the correlation. The coefficient k is supplied to the multiplier 3k, and multiplied by the signal S₇.

As shown in FIG. 13, the wobble signal Swmain of the main track MT detected by the detector is demodulated by the demodulator 2C. Moreover, the output signal of the multiplier 3k is subtracted from the output signal S₆ of the demodulator 2C, and the address demodulation signal Sdemod is obtained.

In the apparatus of FIG. 13, by the aforementioned feedback control, the coefficient of the multiplier 3k is controlled so that ΔS is minimized, that is, the crosstalk of the RF signal from the track ST1 to the address demodulation signal Sdemod is minimized. Thereby, the crosstalk of the RF signal of the track ST1 to the address demodulation signal Sdemod is canceled.

The cancellers 4C and 5C are constituted similarly as the canceller 3C, and the RF signals of the main track MT and track ST2 are canceled similarly as the RF signal of the track ST1 by the aforementioned operation.

As described above, the apparatus 400 of FIG. 13 detects the crosstalk of the RF signal after the demodulation, cancels the crosstalk after the demodulation, and obtains the address demodulation signal. In the apparatus, since the error (crosstalk) is detected from the demodulated wobble signal, the error can advantageously be detected with a high precision.

FIG. 14 shows an apparatus 500 constituted by adding delay units 11, 12, 13, and 14 for delaying the RF signals Srfsub1, Srfmain, and Srfsub2 as detection signals from three detectors, and a push-pull signal Swmain by each predetermined time to the apparatus of FIG. 13.

The delay units 11 to 14 cancel a relative position relation of light spots of the detectors for reading track information of three tracks. Usually, when the tracks disposed adjacent to one another are irradiated with three light spots, these light spots are positioned in positions deviating from one another with respect to a reading direction of the track information, that is, a peripheral direction of the optical disk.

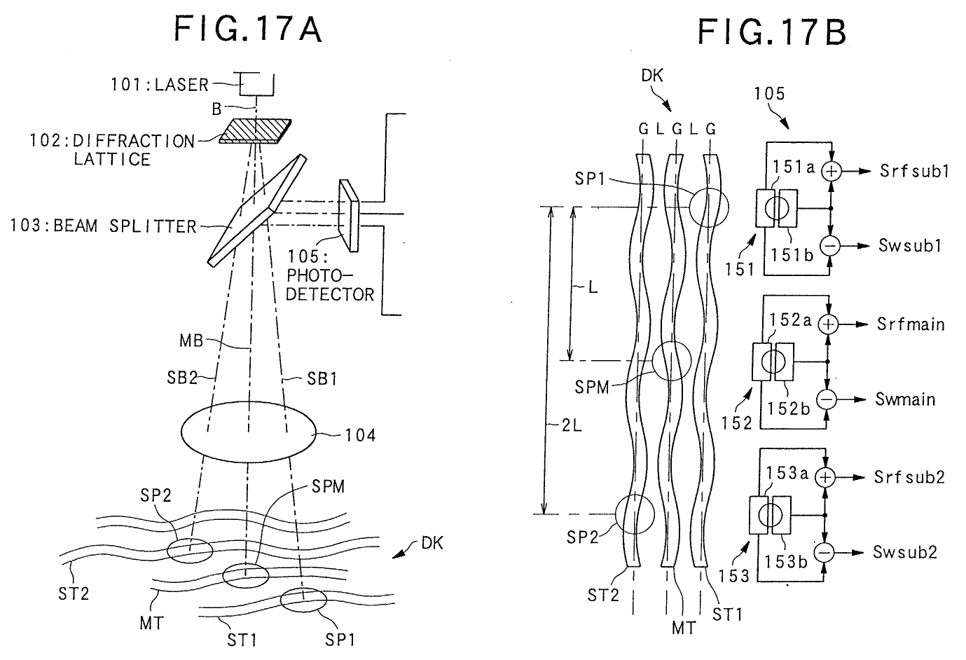

FIGS. 17A and 17B show one example of an optical system for reading the track information. The optical system shown in FIGS. 17A and 17B includes a laser 101, diffraction lattice 102, beam splitter 103, objective lens 104, and photodetector 105.

The laser 101 generates a light beam B which has a predetermined constant strength to reproduce the information, and irradiates the diffraction lattice 102 with the beam. Moreover, the diffraction lattice 102 splits the light beam B into a main beam MB with which the main track MT with the information to be reproduced recorded therein is to be irradiated, and sub beams SB1 and SB2 with which the adjacent tracks ST1 and ST2 disposed on opposite sides of the main track MT are to be irradiated, and irradiates the beam splitter 103 with the beams.

Moreover, the beam splitter 103 transmits the split main beam MB and sub beams SB1 and SB2, and irradiates the objective lens 104 with the beams.

Thereby, the objective lens 104 separately focuses the emitted main beam MB and sub beams SB1 and SB2, and irradiates the main track MT with the main beam MB, the track ST1 with the sub beam SB1, and the track ST2 with the sub beam SB2, respectively. In this case, a light spot SPM is formed in an irradiation position on the main track MT by the main beam MB, a light spot SP1 is formed in the irradiation position on the track ST1 by the sub beam SB1, and a light spot SP2 is formed in the irradiation position on the track ST2 by the sub beam SB2. As shown in FIG. 17A, the light spots SPM, SP1, and SP2 are arranged in a direction inclined with respect to a radius of the optical disk DK. The light spots SPM, SP1, and SP2 are positioned deviating from one another in the peripheral direction (reading direction of the information) of the optical disk DK.

Moreover, reflected lights of the main beam MB and sub beams SB1 and SB2 from the optical disk DK are focused on the beam splitter 103 via reverse optical paths of the original main beam MB and sub beams SB1 and SB2. In this case, by the reflection in the optical disk DK, polarization surfaces of the reflected lights of the main beam MB and sub beams SB1 and SB2 from the optical disk DK are rotated by a slight angle.

Thereby, the beam splitter 103 in turn reflects each reflected light whose polarization surface is rotated, and separately irradiates the photodetector 105 with each reflected light.

As shown in FIG. 17B, the photodetector 105 includes detectors 151, 152, and 153 which separately receive three reflected lights and output push-pull signals. The detector 151 receives the reflected light of the beam SB1, the detector 152 receives the reflected light of the main beam MB, and the detector 153 receives the reflected light of the beam SB2. The detectors 151, 152, and 153 include individual sensors 151a, 151b, sensors 152a, 152b, and sensors 153a, 153b which constitute respective pairs of detectors.

The detectors 151, 152, and 153 generate three detection signals (push-pull signals) Swsub1, Swmain, and Swsub2 obtained as differences of the detection signals of the individual sensors (e.g., 152a, 152b). Moreover, the detectors 151, 152, and 153 generate three detection signals (RF signals) Srfsub1, Srfmain, and Srfsub2 obtained as sums of the detection signals of the individual sensors (e.g., 152a, 152b).

As shown in FIG. 14, the delay units 11 to 14 adjust delay times of the detection signals Srfsub1, Srfmain, Srfsub2, and Swmain in order to cancel the position deviation of the optical spot in the peripheral direction of the optical disk. Thereby, the signals outputted from the delay units 11 to 14 are equivalent to detection signals in a case in which three light spots are arranged in a radial direction of the optical disk.

When the light spot deviates in the radial direction of the optical disk, it is necessary to adjust the timing of the signal, and cancel the crosstalk. Additionally, the constitution corresponding to the delay units 11 to 14 can similarly be applied to any one of the apparatuses of FIGS. 10 to 13. Moreover, the delay unit may delay the signal before or after the demodulation.

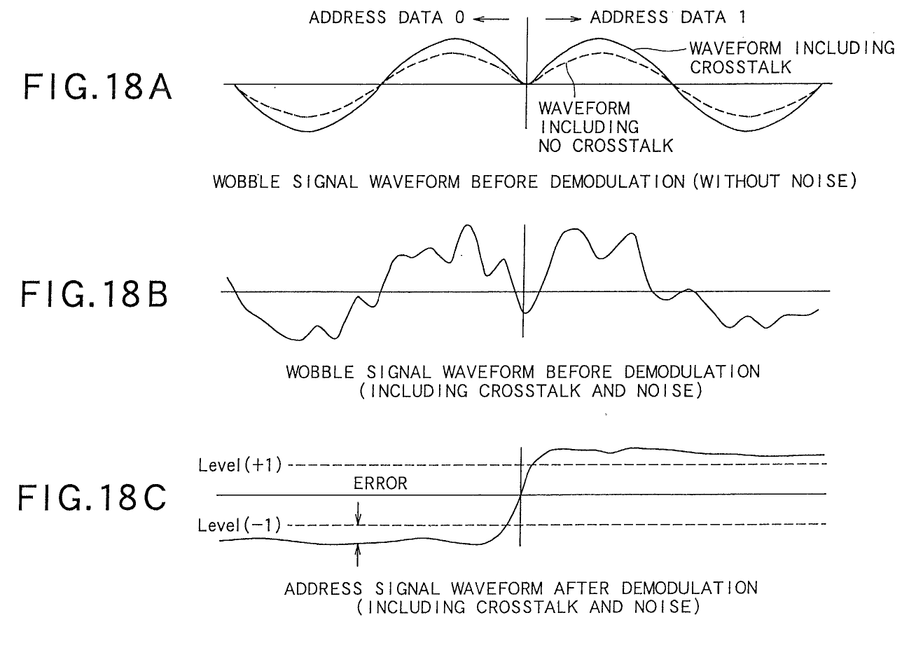

A detection of the error (crosstalk) before/after the demodulation will next be described with reference to FIGS. 18A, 18B and 18C.

FIG. 18A shows the wobble signal waveform which does not include the crosstalk or the noise, and FIG. 18B shows the wobble signal waveform which includes the crosstalk and noise.

When the address data is recorded by phase modulation of the wobble, the wobble signal waveform forms a sine wave as shown in FIG. 18A. This is because the carrier signal with the address data laid thereon is recorded by wobbling the groove in an analog manner. In general, it is relatively difficult to detect the error (crosstalk amount) from the analog signal waveform. Moreover, a random noise is added to the signal before the actual demodulation, and the signal sometimes becomes noisy as shown in FIG. 18B.

On the other hand, FIG. 18C shows a demodulated address signal waveform obtained by demodulating the wobble signal including the crosstalk and noise in the apparatuses of FIGS. 12 to 14. In an ideal case in which there is no crosstalk, the demodulated address signal waveform has two digital levels (Level(+1) and Level(−1)). Therefore, when the deviation amount from the aforementioned ideal signal waveform is detected with respect to the demodulated signal waveform shown in FIG. 18C, it is possible to detect the error (crosstalk). Moreover, since the signal is passed through the low pass filter in the process of the demodulation, the influence of the noise is advantageously reduced. That is, when the error (crosstalk) is detected based on the demodulated signal waveform, it is easier to control the coefficient for the cancellation of the crosstalk from the wobble signal. Therefore, when the coefficient is controlled based on the demodulated signal, the crosstalk cancellation works better, and the address information can more accurately be read.

A method of controlling the coefficient by the coefficient controller will next be described with reference to FIGS. 19 to 25.

FIG. 19 is a schematic diagram showing one example of an applied coefficient control method.

In the example shown in FIG. 19, the method includes the steps of: detecting the error (crosstalk) of the demodulated address signal of the main track after the crosstalk is canceled; and establishing a correlation with the demodulated signal of the track (sub track) disposed adjacent to the main track. The signal of the corresponding adjacent track is subtracted from the signal of the main track with a strength corresponding to the coefficient obtained by integrating the correlation value. By this processing, when the correlation is eliminated, that is, the crosstalk of the signal of the main track is substantially completely canceled, the coefficient is stable in this state.

A method for detecting the error will next be described.

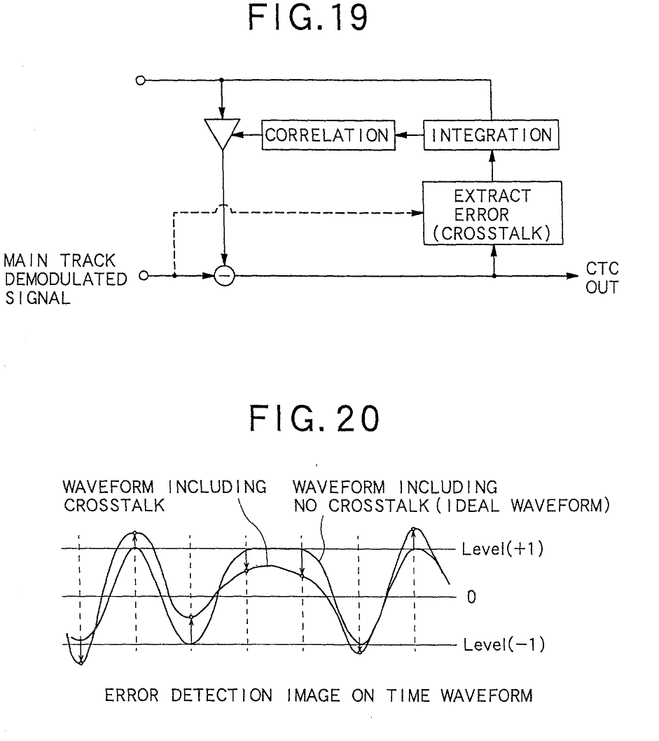

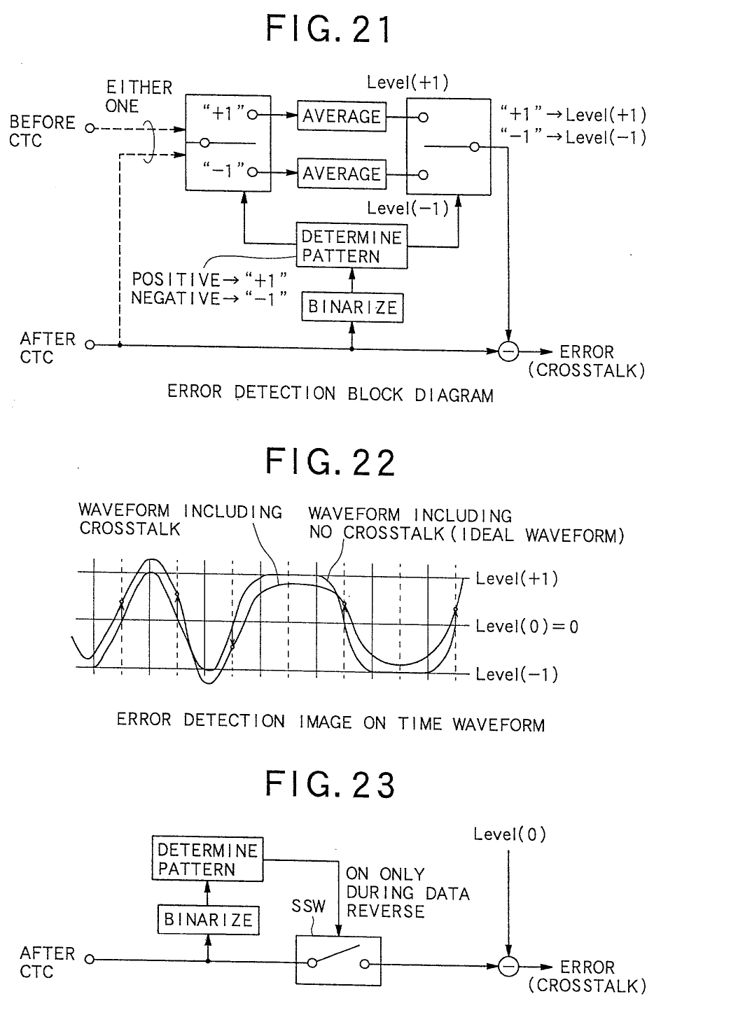

Examples of the method for detecting the error include a method shown in FIGS. 20 and 21.

FIG. 20 is a diagram showing the waveform after the demodulation of the main track and the ideal waveform which does not include the crosstalk, and FIG. 21 is a schematic block diagram for detecting the error.

In this method, the value of the demodulated signal of the main track after the cancellation of the crosstalk is compared with the reference level (two levels of Level(+1) and Level(−1)). A method for determining either one of the binary reference levels for use may include the steps of: binarizing (+1 and −1) the demodulated signal level of the main track; and comparing determined data “+1” with Level(+1); or comparing determined data “−1” with Level(−1). The reference levels Level(+1) and Level(−1) may be determined by averaging the demodulated signal levels of the main track before the cancellation of the crosstalk for each determination level (“+1” and “−1”). Moreover, the reference levels Level(+1) and Level(−1) may be determined by averaging the demodulated signal levels of the main track after the cancellation of the crosstalk for each determination level (“+1” and “−1”).

FIGS. 22 and 23 show that a level in a 0 cross point is used in the method for detecting the error. FIG. 22 is a diagram showing the demodulated waveform of the main track and the ideal waveform including no crosstalk, and FIG. 23 is a schematic block diagram for detecting the error.

As shown in FIGS. 22 and 23, in the error detection method, the signal level in the 0 cross point in the demodulated signal of the main track after canceling the crosstalk is used.

In this case, since the reference level is always Level(0), it is unnecessary to switch the reference level, and the error can advantageously securely be detected without being influenced by a signal amplitude. However, in the 0 cross point, that is, at a timing at which the demodulated signal of the main track should originally turn to 0, it is necessary to sample the signal, and therefore a sampling switch ssw is required. For example, as shown in FIG. 23, when the demodulated signal level of the main track after the crosstalk cancellation is binarized, the sampling switch ssw is turned on at a timing of data change, and it is possible to sample the signal in the 0 cross point.

In this method, the sampling value in the 0 cross point is compared with the reference level Level(0), the difference is integrated as shown in FIG. 19, the signal is averaged with time, and the coefficient is calculated.

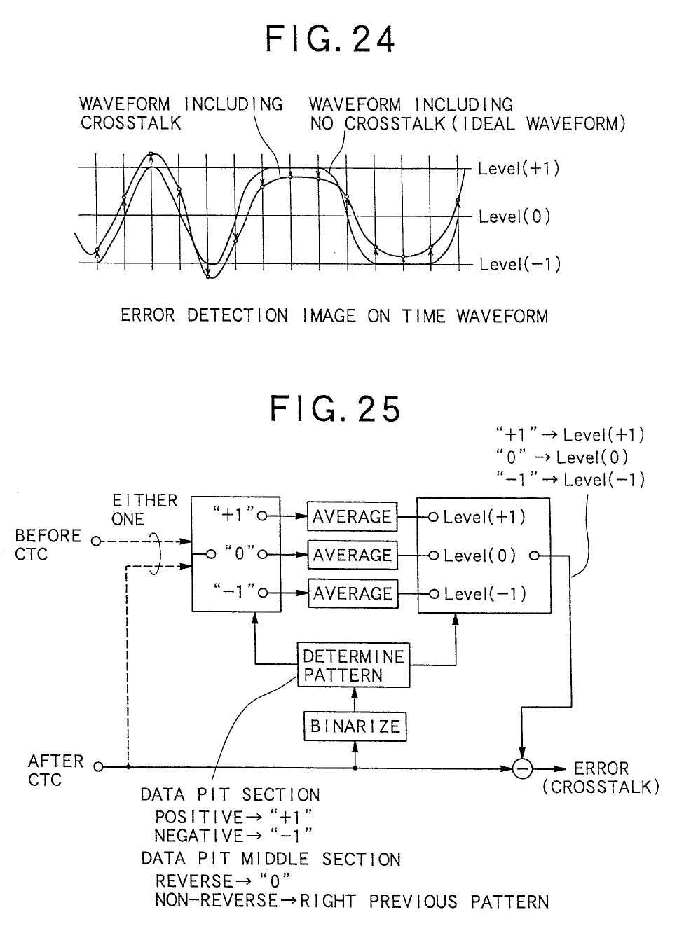

In a method shown in FIGS. 24 and 25, the method for detecting the error includes the steps of: comparing the value of the demodulated signal of the main track after canceling the crosstalk and the value of the 0 cross point with the reference levels (three values of Level(+1), Level(−1), and Level(0)). FIG. 24 is a diagram showing the waveform after the demodulation of the main track and the ideal waveform including no crosstalk, and FIG. 25 is a schematic block diagram for detecting the error.

This method is a combination of the method shown in FIGS. 20 and 21 with the method shown in FIGS. 22 and 23 for use. Any one of three values of the reference level can be determined by means similar to the method shown in FIGS. 20 and 21. Moreover, the 0 cross point can be determined by means similar to the method shown in FIGS. 22 and 23.

Furthermore, the reference level can be determined by averaging the demodulated signal levels of the main track after the crosstalk cancellation for each determination level (“+1”, “0”, and “−1”). Additionally, to determine the reference level, the demodulated signal level of the main track after the crosstalk cancellation may be averaged for each determination level (“+1”, “0”, and “−1”) and determined.

In this method, the error of the demodulated signal of the main track after the crosstalk is canceled is extracted with respect to three values (+1, −1, and 0), therefore the number of samples for the error detection increases, and the influence of the noise, and the like on the coefficient control can advantageously be reduced.

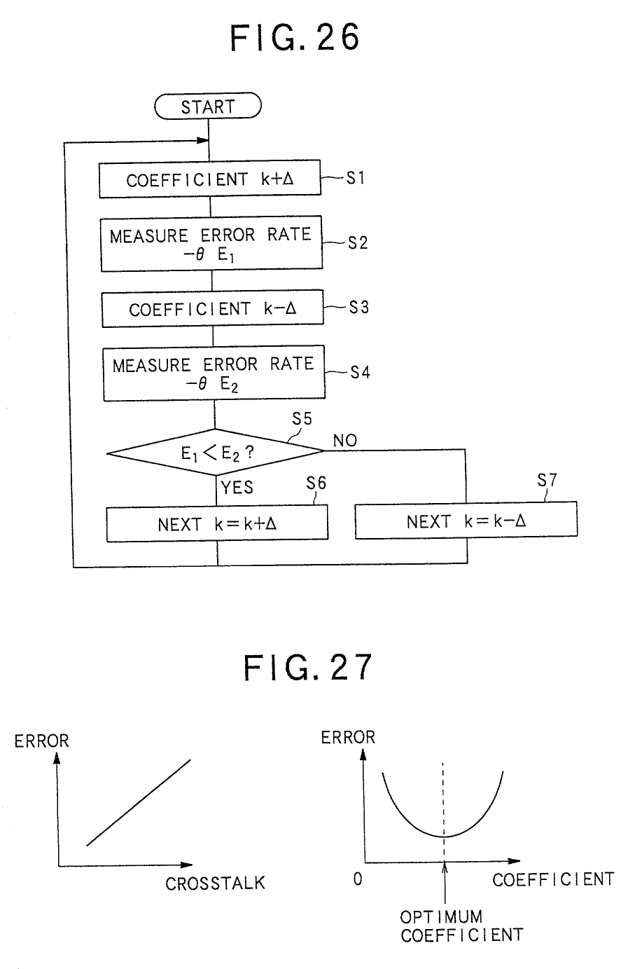

Furthermore, a method for controlling the coefficient to reduce the error rate instead of the method shown in FIGS. 19 to 25 will be described with reference to FIGS. 26 and 27. FIG. 26 is a flowchart showing a processing for controlling the coefficient based on the error rate. FIG. 27 is a diagram showing a relation between the error rate and the crosstalk amount, and a relation between the error rate and the coefficient k.

A method for controlling the coefficient based on the error rate will be described hereinafter.

In step S1 of FIG. 26, the coefficient k (e.g., k1) is increased by a micro amount Δ, and k+Δ is obtained. In step S2, an error rate E1 after the increase of the coefficient k is measured. Conversely to the step S1, in step S3, the coefficient k (e.g., k1) is decreased by the micro amount Δ, and k−Δ is obtained. In step S4, an error rate E2 after the decrease of the coefficient k is measured. In step 5, the error rate of the step S2 is compared with that of the step S4, and it is judged whether or not error rate E1<error rate E2. When the judgment is affirmative, the flow advances to step S6, and a new coefficient is set to coefficient k=k+Δ. Moreover, when the judgment is denied, the new coefficient is set to coefficient k=k−Δ.

The aforementioned processing is successively executed with respect to the respective coefficients k (k1, k2 . . . ), and each coefficient k is thereby controlled to indicate a value at which the error rate is reduced, that is, a value at which the crosstalk decreases (see FIG. 27).

Instead of using the error rate as a parameter to control the coefficient k, a jitter may be used as the parameter to control the coefficient k. In this case, by a processing similar to that of FIG. 26, the coefficient k is controlled in order to minimize the jitter, so that the crosstalk can be minimized.

In the aforementioned example, the wobble is read, while the coefficient is controlled to indicate an optimum value, but the coefficient may be fixed. In this case, the crosstalk amount strongly depends on a track pitch, but the track pitch is usually fixed as a standard in an optical disk system. Therefore, the coefficient k for canceling the crosstalk amount predicted by the simulation assuming the track pitch, or the experimentally measured crosstalk amount may be selected.

For example, with the optical disk having the parameters similar to those of DVD (numerical aperture (NA)=0.6, laser waveform λ=650 nm, track pitch=0.74 μm), an appropriate value of the coefficient k is −0.12 according to the simulation. Therefore, in the second embodiment, when k1, k2 are set to be of the order of −0.1, the crosstalk of the wobble can effectively be canceled.

Additionally, the aforementioned constitution in which the crosstalk of the RF signals from the main track and the tracks disposed on the opposite sides of the main track is canceled has been described. For example, when the light spot deviates to one side from the center line of the main track, only the crosstalk of the RF signal from the main track and one of the adjacent tracks may be canceled.

Moreover, when the crosstalk of the RF signal from the main track can actually be ignored, only the crosstalk of the RF signal from the track adjacent to the main track may be canceled without canceling the crosstalk of the RF signal from the main track. Conversely, when the crosstalk of the RF signal from the track adjacent to the main track can actually be ignored, only the crosstalk of the RF signal from the main track may be canceled.

Furthermore, as a system for recording the address information of the optical disk by the wobble, a system for recording an FM-modulated wobble in accordance with the address information, and a system for recording a phase-modulated wobble in accordance with the address information have been proposed. However, an application range of the information reproduction apparatus of the present invention is not limited with respect to the recording system of the address information. Moreover, the information recorded with the wobble is not limited to the address information.

Additionally, the RF detection device is not limited to the sum of the outputs of the two-split photodetector shown in FIG. 17B. For example, a photodetector having no split, or a detection method for obtaining the RF information may be used. Furthermore, the RF information may be recorded as a recording mark or an emboss pit.

Embodiment

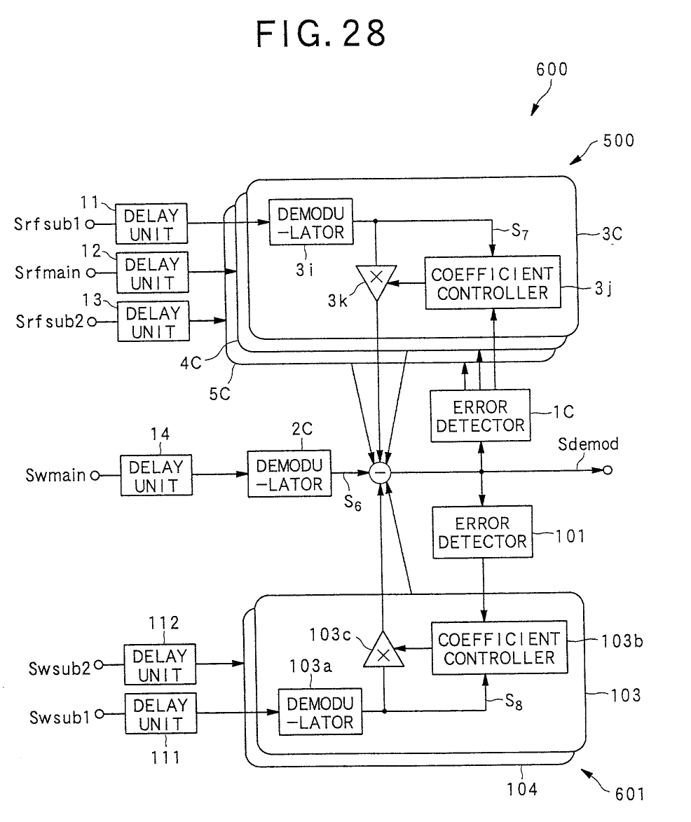

An embodiment of the information reproduction apparatus of the present invention will be described hereinafter with reference to FIG. 28. In the embodiment, an example will be described in which the present invention is applied to the information reproduction apparatus for reading the information (particularly the wobble or address information) of the optical disk using the system for recording the address information by the phase modulation of the wobble.

FIG. 28 is a diagram showing the constitution of the information reproduction apparatus according to the embodiment. An information reproduction apparatus 600 shown in FIG. 28 includes the optical system shown in FIGS. 17A and 17B (tot shown in FIG. 28), and also includes the apparatus 500 shown in FIGS. 13 and 14. A redundant description of the optical system shown in FIGS. 17A and 17B and the apparatus 500 is omitted.

As shown in FIG. 28, the information reproduction apparatus 600 includes the apparatus 500 for canceling the crosstalk of the RF signal mixed in the wobble signal of the main track MT, and an apparatus 601 for canceling the crosstalk of the wobble signals of the tracks ST1 and ST2 mixed in the wobble signal of the main track MT.

The apparatus 601 includes: a delay unit 111 for receiving a wobble signal Swsub1 of the track ST1 as a difference signal (push-pull signal) of the detector 151 (FIG. 17B); a delay unit 112 for receiving a wobble signal Swsub2 of the track ST2 as the difference signal (push-pull signal) of the detector 153 (FIG. 17B); an error detector 101 for detecting the error (crosstalk) of the demodulated wobble signal of the main track; a canceller 103 for canceling the wobble signal of the track ST1; and a canceller 104 for canceling the wobble signal of the track ST2.

The canceller 103 includes a demodulator 103a for demodulating the wobble signal Swsub1 of the track ST1 outputted as the difference signal (push-pull signal) from the detector 151 (FIG. 17B), a coefficient controller 103b, and a multiplier 103c to which the coefficient outputted from the coefficient controller 103b is given.

The delay units 111 and 112, together with the delay units 11 to 14 (FIG. 14), cancel the relative position relation of the light spots of the detectors for reading the track information of three tracks.

The error detector 101 detects and outputs the error ΔS included in the wobble signal Sdemod obtained by canceling the crosstalk from the output signal S₆ of the demodulator 2C. The coefficient controller 103b detects the correlation between the error ΔS and the signal S₈ obtained by demodulating the wobble signal Swsub1, and outputs the coefficient k corresponding to the correlation. The coefficient k is given to the multiplier 103c, and multiplied by a signal S₈.

As shown in FIG. 28, the wobble signal Swmain of the main track MT detected by the detector is demodulated by the demodulator 2C. Moreover, the output signal of the multiplier 103c is subtracted from the output signal S₆ of the demodulator 2C, and the address demodulation signal Sdemod is obtained.

In the apparatus 600 shown in FIG. 28, by the aforementioned feedback control, the coefficient of the multiplier 103c is controlled so that ΔS is minimized, that is, the crosstalk of the wobble signal from the track ST1 to the address demodulation signal Sdemod is minimized. Thereby, the crosstalk of the wobble signal of the track ST1 to the address demodulation signal Sdemod is canceled.

The canceller 104 is constituted similarly as the canceller 103, and the wobble signal of the track ST2 is canceled similarly as the wobble signal of the track ST1 by the aforementioned operation.

As described above, in the apparatus 600 of FIG. 28, the apparatus 500 cancels the crosstalk of the RF signals of the track ST1, main track MT, and track ST2 mixed in the wobble signal of the main track MT. Moreover, the apparatus 601 cancels the crosstalk of the wobble signals of the tracks ST1 and ST2 mixed in the wobble signal of the main track MT. Since the apparatus 600 cancels the crosstalk of both the RF signal and the wobble signal, the crosstalk mixed in the wobble signal of the main track MT can efficiently be removed.

In the present embodiment, the apparatuses 500 and 601 for detecting the error (crosstalk) after the demodulation and canceling the crosstalk after the demodulation are used. However, instead of these apparatuses, other apparatuses may also be used. The error (crosstalk) may be detected before or after the demodulation. Moreover, the crosstalk may be canceled before or after the demodulation. Various types of apparatuses 100 to 500 shown in FIGS. 10 to 14 can appropriately be used. Furthermore, different types of apparatuses may be used to cancel the crosstalk of the RF signal, and cancel the crosstalk of the wobble signal.

The entire disclosure of Japanese Patent Application No. 2001-98236 filed on Mar. 30, 2001 including the specification, claims, drawings and summary is incorporated herein by reference in its entirety.

What is claimed is:

1. An information reproduction apparatus which reads wobble information and RF information from an optical recording medium, the apparatus comprising:
a wobble detection device for detecting a wobble signal from the wobble information;
an RF detection device for detecting an RF signal from the RF information; and
a crosstalk cancel device for using the RF signal to cancel a crosstalk arising from the RF information included in the wobble signal.

2. The information reproduction apparatus according to claim 1 wherein the wobble detection device detects the wobble signal from a first track, and
the RF detection device detects the RF signal from a second track disposed adjacent to the first track.

3. The information reproduction apparatus according to claim 2, further comprising a position deviation compensation device for compensating a timing corresponding to a position deviation with respect to an information reading direction of the wobble detection device and the RF detection device,
wherein the wobble signal and the RF signal whose timings are adjusted by the position deviation compensation device are used to execute a control in the crosstalk cancel device.

4. The information reproduction apparatus according to claim 1 wherein the wobble detection device detects the wobble signal from a first track, and the RF detection device detects the RF signal from the first track.

5. The information reproduction apparatus according to claim 1, further comprising:
a crosstalk extraction device for extracting the crosstalk included in the wobble signal; and
a coefficient control device for controlling a coefficient based on the crosstalk extracted by the crosstalk extraction device,
wherein the crosstalk cancel device cancels the crosstalk by the coefficient calculated by the coefficient control device.

6. The information reproduction apparatus according to claim 5 wherein the coefficient control device calculates a correlation between the crosstalk extracted by the crosstalk extraction device and the RF signal, and controls the coefficient for use in the crosstalk cancel device so that the correlation is reduced.

7. The information reproduction apparatus according to claim 5, further comprising:
a wobble demodulation device for demodulating the wobble signal; and
an RF demodulation device for demodulating the RF signal,
wherein the crosstalk extraction device extracts the crosstalk from the signal demodulated by the wobble demodulation device, and
the coefficient control device controls the coefficient based on the correlation between the crosstalk extracted by the crosstalk extraction device and the signal demodulated by the RF demodulation device.

8. The information reproduction apparatus according to claim 5 wherein the crosstalk extraction device comprises data pattern determination device for determining a data pattern based on a value of an output signal of the wobble demodulation device after the crosstalk is canceled, and reference level generation device for generating a reference level corresponding to a determined result of the data pattern determination device, and
the reference level is compared with the value of the output signal of the wobble demodulation device after the crosstalk is canceled, and the crosstalk is extracted.

9. The information reproduction apparatus according to claim 1, further comprising error rate detection device for detecting an error rate of the wobble signal,
wherein the crosstalk cancel device cancels the crosstalk so that the error rate detected by the error rate detection device is reduced.

10. The information reproduction apparatus according to claim 1, further comprising: jitter detection device for detecting a jitter of the wobble signal,
wherein the crosstalk cancel device cancels the crosstalk so that the jitter detected by the jitter detection device is reduced.

11. The information reproduction apparatus according to claim 1, wherein the wobble detection device detects the wobble signal from a first track, and the RF detection device comprises first RF detection device for detecting the RF signal from the first track, second RF detection device for detecting the RF signal from a second track disposed adjacent to the first track, and third RF detection device for detecting the RF signal from a third track which is adjacent to the first track and is different from the second track.

12. An information reproduction method in which wobble information and RF information of an optical recording medium are read, the method comprising the processes of:
detecting a wobble signal from the wobble information;
an RF detecting process of detecting an RF signal from the RF information; and
using the RF signal to cancel a crosstalk arising from the RF information included in the wobble signal.
